(19) United States
(12) Patent Application Publication
(10) Pub. No.: US 2011/0320360 A1
(43) Pub. Date: Dec. 29, 2011

(54) Method for Recycling Materials

(76) Inventor: Steven D. Murray, Jacksonville, AL (US)

(21) Appl. No.: 12/825,490

(22) Filed: Jun. 29, 2010

(51) Int. Cl. G06Q 50/00; G06Q 30/00; G06Q 10/00

(52) U.S. Cl. 705/80; 705/308; 705/14.71

(57) ABSTRACT

A method for recycling materials comprising the steps of generating a first revenue stream by forming a contract via a computer between an advertiser and a promoter for recycling bags printed with the advertiser's promotions and/or advertisements, manufacturing the branded recycle bags based on the specifications in the contract and distributing the branded recycle bags to groups comprising members. The method further comprises the steps of the members collecting recyclables utilizing the branded recycle bag, discarding the branded recycle bags into designated collection bins, transporting the collected recycling materials from the collection bin to a recycling facility via a transporter, and, the recycling facility processing the collected recycling materials to generate a second revenue stream. The first revenue stream is allocated between the promoter and the groups utilizing the branded recycling bags and the second revenue stream is allocated between the recycler and the groups utilizing the branded recycling bags.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The preferred embodiment relates generally to a method for recycling materials, and more specifically to a method of recycling via branded containers that generates two revenue streams, the first revenue stream between a promoter and a community group, and the second revenue stream between a recycler and the community group.

2. Description of Related Art

Recycling has been practiced for thousands of years. Prior to the industrial age, one reason many individuals practiced recycling in some form was because materials were scarce and not produced quickly and cheaply. Additionally, mass production during the industrial age created waste and disposable goods that led to environmental problems. In fact, recycling became a way to survive during the Great Depression in the 1930s.

Fortunately, recycling efforts continued even after the Great Depression. For instance, recycling remained popular during the 1940s as a way to support war efforts during World War II. Additionally, the 1970s introduced the modern concept of environmental conservation and the idea of Earth Day. However, even in light of such recycling initiatives, households and individuals were predominantly the only recyclers and large-scale recycling programs were rare.

Luckily, recycling has increased slowly from year to year, in part due to public acceptance and improved economics of recycling, such as, the creation of laws benefitting or requiring certain products be recovered or recycled. For example, many large industries and firms contain, recover and/or recycle certain wastes as required by the Federal RCRA (Resource Conservation and Recovery Act) or the CERCLA (Comprehensive Environmental Response, Compensation and Liability Act). As a result, various recycling programs have been enacted to promote recycling efforts. For instance, small homegrown recycling programs have recovered tons of recycled products, ONP (old newspaper), plastics, aluminum, and many other materials, including trash and garbage. The motivation for such programs is largely environmental awareness, waterfront cleanups and road adoption by groups and clubs, and often financial.

More recently, generating revenue has been a driving force for recycling efforts. However, small recyclers have only been compensated on the amount of recycled materials recovered and delivered to recycling facilities. As a result, small recyclers lack incentives to continue with beneficial recycling programs because they cannot recover enough money to break even on the expenses associated with their recycling programs. Additionally, small recyclers are unable to provide additional monetary incentives to individuals for their involvement in the recycling process.

Accordingly, several recycling programs have been enacted to overcome the revenue problems associated with smaller recyclers. One method teaches an incentive-based waste reduction system. A software program manages the relationship between a recycling customer, a recycling processor and a vendor offering recycling incentives. In such a method, the recycling customer collects and deposits recyclable materials into collection bins. Subsequently, the hauler makes stops to the collection bins to pick up the recycled materials. The hauler then processes the collected materials and obtains values associated with the collected materials utilizing a variety of mathematical calculations. These values are then adjusted into the form of a credit that participating customers can utilize in different variations, one of which is associating credits with a participating vendor's promotion. While such a method does generate revenue streams between a customer, a hauler and a vendor, it does not utilize branded containers to generate an additional revenue stream in the recycling process, nor does it reward customers based on utilization of the branded containers.

Another method teaches the collection of recyclable materials, in which a customer fills bags having a customer code with recyclable materials and places the bag outside their house or in a collection bin. A waste management company subsequently picks up and processes the recyclable materials. The customer who is associated with each bag is credited by the waste management company for their involvement in the recycling process. While such a method may utilize a bag that has an exterior with space for advertising, it does not reward a customer based on their use of a particularly branded bag. That is, the customer only receives incentives from the waste management company, but does not receive financial incentives from an advertising company if they utilize branded bags with various entity advertisements.

Yet another method teaches the managing of advertisement space to promote the realization of a recycling oriented society. An intermediary computer manages the relationship between advertisers and producers of goods to facilitate the branding of goods with advertisements. In such a method, participating producers of goods may allocate at least a part of the advertising revenue generated by the program to the cost of the disposal of waste and the recycling process. While such a method allows a vendor to pay a fee for their advertisement on a particular good, and the fee may be utilized to cover the cost of the recycling process, it does not teach utilizing a part of the advertising revenue to grant cashback rewards to customers who utilize a branded bag indicative of a particular vendor.

Therefore, it is readily apparent that there is a need for a method of recycling that generates revenue and provides incentives for participants to utilize branded recycle bags while collecting recyclable materials.

### BRIEF SUMMARY OF THE INVENTION

Briefly described, in a preferred embodiment, the present invention overcomes the above-mentioned disadvantages and meets the recognized need for such a method for recycling materials. First, a contract for manufacturing recycling bags is formed between an advertiser and a promoter utilizing selection via a computer, wherein the bags have advertising thereon for the advertiser and/or its products, thereby generating a first revenue stream. Second, a manufacturer produces the branded recycling bags based on the specifications of the contract, in which the recycling bags are printed with promotions and/or the advertisements for the advertiser and/or its products. A distributor then supplies the branded recycling bags to a group comprising members, such as, for exemplary purposes only, a community group. The members then utilize the branded recycling bags to collect recyclables, and subsequently deposit the branded recycling bag containing recyclables into a designated recycle bin. A recycling truck then transports the collected recyclables to a recycler. The recycler then processes the recyclable materials, thereby generating a second revenue stream. The first revenue stream and the second revenue stream are selectively allocated amongst group members who utilize the branded recycling bag to collect recyclables for the recycling process.

While the recycling process is typically for use with non-profit groups for fund-raising activities, it will be recognized by those skilled in the art that the method for recycling materials could be utilized by both non-profit and for-profit organizations.

According to its major aspects and broadly stated, the present invention in its preferred form is a method for recycling materials comprising the steps of generating a first revenue stream by forming a contract for branded recycling bags between an advertiser and a promoter via a computer, a manufacturer producing the branded recycling bags based on specifications of the contract, a distributor supplying the branded recycling bags to a group comprising members, members collecting recyclables with the branded recycling bags, the members depositing full branded recycling bags in designated recycle bins, a recycling truck collecting and transporting the full branded recycling bags to a recycler, and processing of the recyclables by the recycler, thereby generating a second revenue stream.

The contract between the advertiser and the promoter is formed by the advertiser accessing the Internet via the computer. The promoter connects to a web interface and establishes a promoter account, which comprises a promoter alert system, which alerts the promoter when an advertiser bids on the promoter's recycle bag project plan. The recycle bag project plan typically comprises a minimum payment to be made by an advertiser who agrees to the plan and the promoter's plan guidelines. The advertiser connects to the web interface and establishes an advertiser account which comprises an advertiser alert system to alert the advertiser when the promoter agrees to contract with the advertiser.

The advertiser selectively browses recycle bag project plans posted on the server web interface by promoters and views the data associated with each of the recycle bag project plans. The advertiser selectively bids on the recycle bag project plan so long as the advertiser's bid is higher than the payment floor entered by the promoter for that particular recycle bag project plan.

The advertiser enters advertising data, which is typically a preliminary design of a recycle bag printed with promotions and/or advertisements. The recycle bag project design is uploaded through the server web interface to the server. The advertising data consists of, for exemplary purposes only, advertiser's plan guidelines, advertisement printing specifications, payment floors, and the like. It will be recognized by those skilled in the art that other information can be entered and stored in the advertiser account by the advertiser, such as, for exemplary purposes only, information about the advertiser, customer data, and the like.

After the advertiser places the bid on the recycle bag project plan, the promoter alert system notifies the promoter. The promoter selectively views and/or accepts the bid from the advertiser. If the promoter does not accept the advertiser's bid, then the advertiser alert system notifies the advertiser that the bid is terminated. If the promoter accepts the advertiser's bid, then the promoter's recycle bag project plan is replaced with the contract from the promoter, which comprises terms, such as, for exemplary purposes only, pricing structure, duration of run time, location of destination or target market, and the like. The advertiser may then either accept or decline the terms of the contract. If the advertiser does not accept the terms of the contract, then the contract is terminated. If the advertiser accepts the terms of the contract, then the promoter is notified via the promoter alert system and an official contract is formed between the advertiser and the promoter, thereby generating the first revenue stream, which is allocated between the group participating in the recycling process and the promoter and the advertiser.

Upon accepting the terms of the contract, the promoter receives the advertisement printing specifications provided by the advertiser and creates a recycle bag design based on the advertisement printing specifications. The promoter then assigns the recycle bag design to the manufacturer. The manufacturer reviews the advertisement printing specifications. If the advertisement printing specifications are not viable, then the manufacture notifies and returns the recycle bag design to the promoter. If the recycle bag design has viable specifications, then the manufacturer approves the recycle bag design and notifies the promoter.

After the manufacturer approves a recycle bag design, the promoter mails, emails or similarly conveys a blank order form to a group that wants to participate in recycling initiatives. The group completes the blank order form with order information, such as, for exemplary purposes, group name, sponsor name, address, phone number, number of bags, recycling bin locations, and the like. The group then returns the completed order form to the promoter. The promoter then creates a work order based upon the receipt of the completed order form from the group. The promoter then forwards the completed work order to the manufacturer. The manufacturer produces the branded recycle bags based on the work order and attaches certification tags to each of the branded recycle bags, thereby creating tagged recycle bags. The manufacturer then assembles a lot comprising the tagged recycle bags, a liability release form, a certification form and an instruction booklet. It will be recognized by those skilled in the art that a single serial number may be allocated to a group of bags in lieu of tagging individual bags.

The manufacturer then arranges for the distributor to transport the lot to the group. The distributor conveys the lot to the group via a bill of lading and provides a copy of the bill of lading to the manufacturer.

Upon receiving the lot, the group reads the instruction booklet, signs the liability release form, and returns the signed liability release form to the promoter. The group then distributes the tagged recycle bags to each of its members, which comprise, for exemplary purposes only, individuals, families, communities, colleges, associations, clubs and/or churches. Each of the members then begin collecting recyclables in the tagged recycle bags until they are full, thereby creating full recycle bags. The members then deposit the full recycle bags in designated recycle bins. Each member then notifies the group that he or she has deposited a full recycle bag in the designated recycle bin. The group then tabulates the members that have deposited full recycle bags into recycle bins on the certification form. The group then signs and subsequently submits the signed certification form to the promoter.

After receiving the signed certification form from the group, the promoter generates logistics data, which are then forwarded to the recycler. Logistics data comprise, for exemplary purposes only, the location of designated collection bins, the number of members that have deposited full recycle bags, and the like. Upon receiving logistics data from the promoter, the recycler assigns recycling trucks to collect the full recycle bags from the designated recycle bins. The recycling trucks collect the full recycle bags and the certification tags on the full recycle bags. The recycling trucks then tabulate the certification tags on a collection record form. The recycling trucks then transport the full recycle bags to the recycler and submit the collection record form to the recycler. The recycler processes the recyclable materials and calculates a collection rebate based on the recyclable material processed. The recycler then submits the collection rebate and the collection record form to the promoter, thereby generating the second revenue stream. A first portion of the second revenue stream is retained by the recycler and a second portion of the second revenue stream is allocated to the promoter.

The promoter compares the signed certification form previously received from the group and the collection record form received from the recycler. If the signed certification form does not match the certification tags documented on the collection record form, then the promoter sends a “decline” response to the group. If the signed certification form matches the certification tags documented on the collection record form, then the promoter calculates an advertisement rebate and issues a final payment to the group. The group then distributes the final payment to its members who participated in collecting the recyclable materials.

In another embodiment, the present invention is a method of recycling materials comprising the steps of generating a first revenue stream by forming a contract for branded bags between an advertiser and a promoter via a computer, manufacturing the branded bags, distributing the branded bags to groups, wherein the groups collect recycling materials in the branded bag and a recycler processes the recycling materials collected by the groups, thereby generating a second revenue stream. A portion of the first and second revenue stream is allocated to the groups.

More specifically, the present invention is a method for recycling materials by forming a contract between an advertiser and a promoter, thereby generating a first revenue stream. The promoter accesses the Internet utilizing a computer and a web interface, the computer being in communication with a server, and establishes a promoter account having a promoter alert system. The promoter creates a recycle bag project plan for recycling bags that are printed with advertisements and/or promotions by entering promotion information, such as, for exemplary purposes only, plan guidelines and a payment minimum. The plan guidelines comprise, for exemplary purposes only, pricing structure, duration of run time, destination or target market, and the like.

The promoter's account and recycle bag project plan are then stored on the server. It will be recognized by those skilled in the art that the promoter may store other information on the promoter account, such as, for exemplary purposes only, contact information, marketing plans, customer data, and the like.

The advertiser subsequently connects to the server web interface and accesses the Internet. The advertiser establishes an advertiser account, which comprises an advertiser alert system. The advertiser then browses recycle bag project plans and views the advertisement plan guidelines and the payment floor or minimum for various recycle bag project plans. If the advertiser is not interested in obtaining services for the recycle bag project plan, then the advertiser continues to browse recycle bag project plans.

If the advertiser is interested in obtaining services for the recycle bag project plan, then the advertiser places a bid and provides advertisement print specifications, which are stored in the advertiser account. If the bid is higher than the payment minimum for the selected recycle bag project plan, then the promoter alert system sends a message to the promoter. If the bid is lower than the payment minimum, then the advertiser receives an invalid prompt.

Advertisement print specifications comprise information such as, for exemplary purposes only, print layout or any other details required by the advertising company. The payment floor or minimum is the lowest amount the promoter is willing to accept for advertising on recycling bags.

After the promoter receives an alert from the alert system, the promoter selectively views the bid from the advertiser. If the promoter does not accept the bid, then the advertiser alert system sends an alert to the advertiser indicating that the bid has been rejected. If the promoter accepts the bid from the advertiser, then the contract is drafted and sent to the advertiser account. The contract comprises contract terms, such as, for exemplary purposes only, shipping and/or payment information, termination and/or warranty clauses, and the like. The advertiser reviews the contract terms. If the advertiser does not agree to the contract terms, then the contract is terminated. If the advertiser agrees to the contract terms, then the promoter alert system sends an alert to the promoter and the contract is established. The advertisement print specifications are then sent to the promoter's account.

After viewing the advertisement print specifications, the promoter designs a recycle bag design. The promoter then assigns the recycle bag design to the manufacturer. The manufacturer reviews the advertisement print specifications of the recycle bag design. If recycle bag design does not have viable advertisement print specifications, then the promoter is notified and a new recycle bag design is drafted by the promoter and re-submitted to the manufacturer for approval. If the recycle bag design does have viable advertisement print specifications, then the recycle bag design is approved by the manufacturer.

The promoter then mails and/or electronically conveys a blank order form to groups. The groups fill in the blank order form with order form data, which comprise, for exemplary purposes only, number of bags, time of delivery, contact information, and the like. The groups then sign the order form, thereby creating a signed order form. The groups then return the signed order form to the promoter. The promoter creates a work order based on the signed order form from the groups and forwards the work order to the manufacturer.

The manufacturer utilizes the work order to produce the recycle bags and attaches certification tags to each of the recycle bags. The manufacturer then assembles a “lot” comprising tagged recycle bags, a liability release form, a certification form and an instruction booklet. The manufacturer then arranges for a distributor to transport and supply the lot to the group via a bill of lading and provides a copy of the bill of lading to the manufacturer. Upon receipt of the lot, the group reads the instruction booklet. The group then completes and signs the liability release form. The group returns the signed liability release form to the promoter and distributes the tagged recycle bags to its members.

The members of the group fill the tagged recycle bags with recyclables and then transport the full recycle bag to recycle bins. The members then certify to the group that they have filled and deposited the full recycle bag into the recycle bins. The group tabulates the number of members that deposited full recycle bags on the certification form. The group then signs the certification form and submits the signed certification form to the promoter.

Upon receiving the signed certification form from the group, the promoter generates logistics data, which are then forwarded to the recycler. Subsequently, the recycler assigns recycle trucks to collect the full recycle bags from the designated recycle bins. The operators of the recycle trucks tabulate the certification tags attached to the collected recycle bags on a collection record form. The operators of the recycle trucks then return collected recycle bags to the recycler and submit the collection record form to the recycler.

The recycler processes recyclables, thereby generating the second revenue stream. The recycler subsequently calculates a collection rebate based on the amount of recyclables processed. The recycler then sends the collection rebate and the collection record form to promoter. The promoter compares the signed certification form to the collection record form. If the signed certification form does not match the collection record form, then the promoter contacts the group with a decline response. If the signed certification form does match the collection record form, then the promoter calculates an advertisement rebate. The promoter then calculates a final payment. The promoter then issues the final payment to the group and the group distributes the final payment to its members.

Accordingly, a feature and advantage of the present invention is its ability to generate multiple revenue streams, which may be allocated to participants that utilize branded recycling bags during the recycling process.

Another feature and advantage of the present invention is its ability to raise awareness towards recycling issues while also supporting various community groups.

Still another feature and advantage of the present invention is its ability to generate two independent revenue streams which can be shared between a promoter and a community group.

Yet another feature and advantage of the present invention is its ability to allow a store or a company to advertise their name or logo on specialized recycling bags.

Yet still another feature and advantage of the present invention is its ability to provide a portal for companies and stores to create a recycling plan and allow promoters to bid on such recycling plans.

A further feature and advantage of the present invention is its ability to allow community members to drop off all collected recyclables at a single location.

Still another feature and advantage of the present invention is its ability to provide monetary incentives and also compensate community groups for utilizing specialized bags while collecting recyclables.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred Embodiment with reference to the accompanying drawing figures, in which like reference numerals denote similar structure and refer to like elements throughout, and in which:

FIG. 1 is a flowchart illustrating a method for recycling materials according to a preferred embodiment;

FIG. 2 is a detailed flowchart depicting a promoter creating a recycle bag project plan according to a preferred embodiment;

FIG. 3 illustrates components stored on a server according to a preferred embodiment;

FIG. 4 is a detailed flowchart depicting an advertiser bidding on a promoter's recycle bag project plan according to a preferred embodiment;

FIG. 5 is a flowchart depicting the creation of a contract between an advertiser and a promoter according to a preferred embodiment;

FIG. 6 is a flowchart illustrating a method for designing and approving a recycle bag design according to a preferred embodiment;

FIG. 7 is a flowchart depicting the creation of a work order for a recycle bag project plan according to a preferred embodiment;

FIG. 8 is a detailed flowchart of assembling a recycling lot to transport to a group according to a preferred embodiment;

FIG. 9 illustrates the components of a recycling lot according to a preferred embodiment;

FIG. 10 is a flowchart illustrating a method for a group receiving a lot according to a preferred embodiment;

FIG. 11 is a detailed flowchart documenting the utilization of tagged recycle bags to collect recyclables according to a preferred embodiment;

FIG. 12 is a detailed flowchart of a recycler tabulating a collection record to send to a promoter according to a preferred embodiment; and

FIG. 13 is a detailed flowchart of a promoter issuing final payment to a group according to a preferred embodiment.

### DETAILED DESCRIPTION OF THE PREFERRED AND SELECTED ALTERNATE EMBODIMENTS OF THE INVENTION

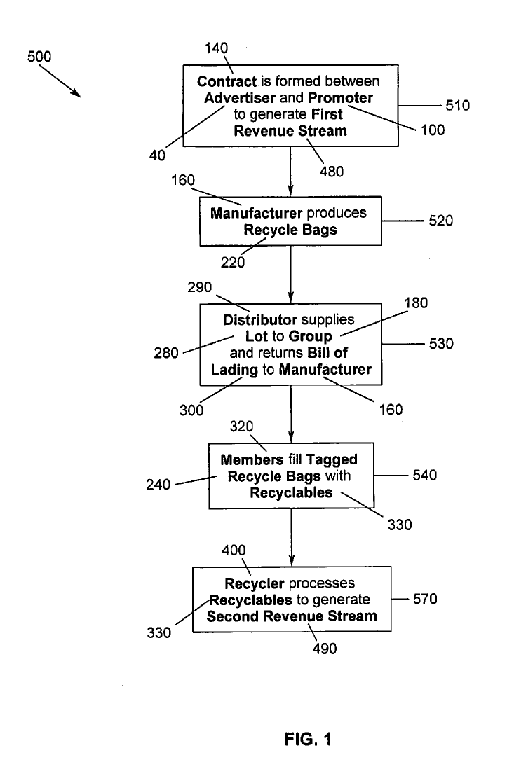

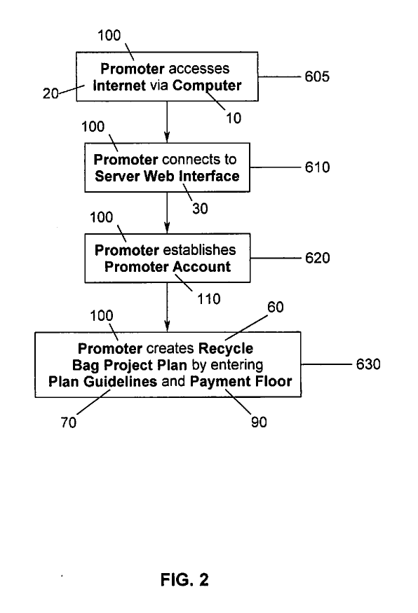

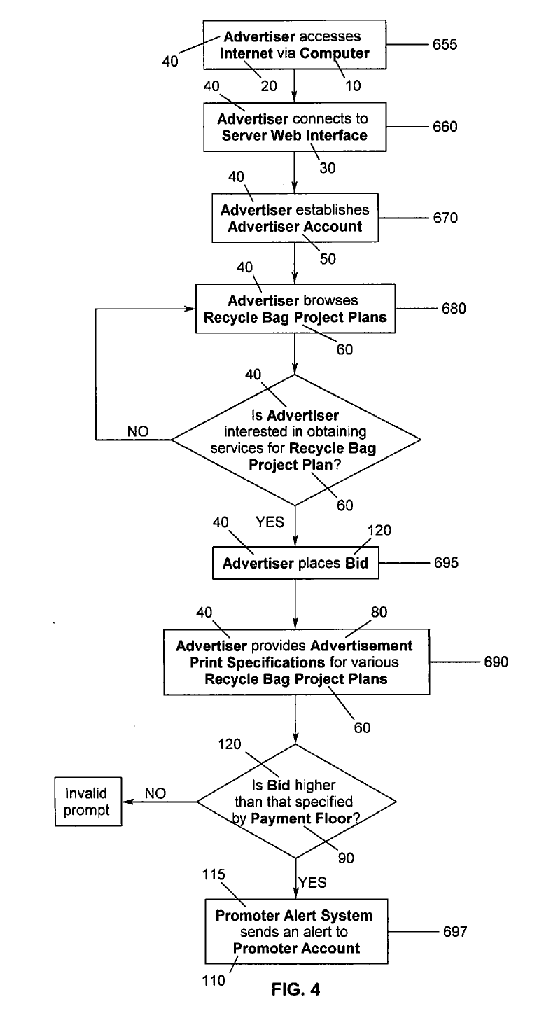

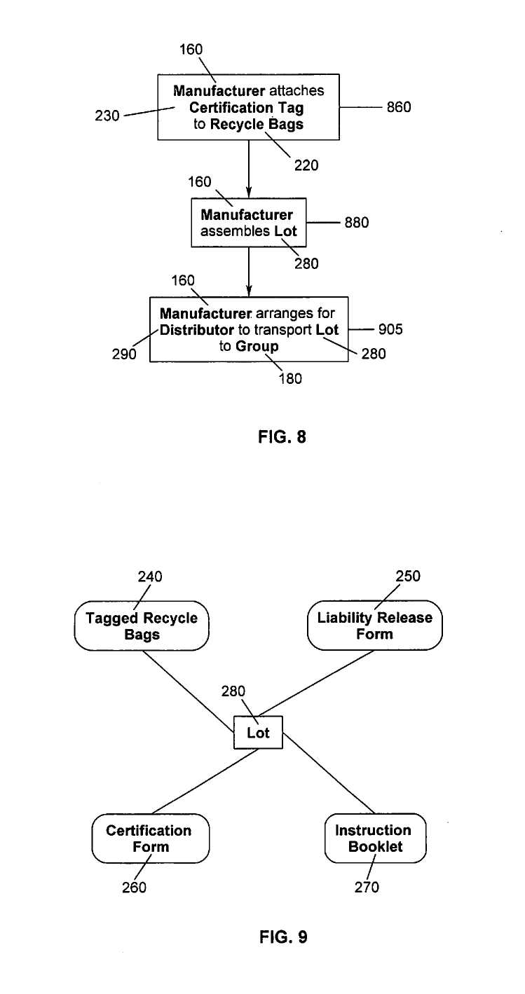

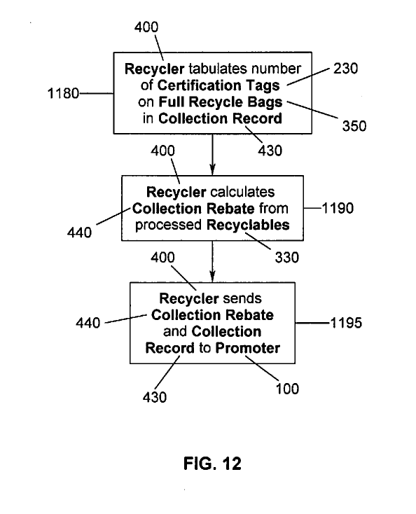

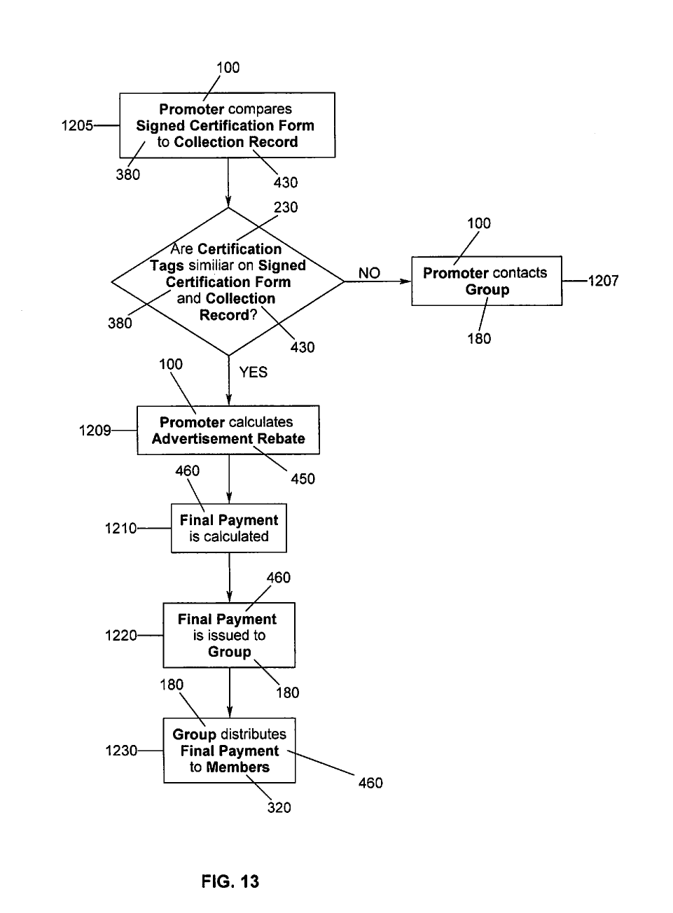

In describing the preferred and selected alternate embodiments of the present invention, as illustrated in FIGS. 1-13, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-5, method for recycling materials 500 comprises contract 140, wherein contract 140 is formed between advertiser 40 and promoter 100 via step 510 resulting in first revenue stream 480.

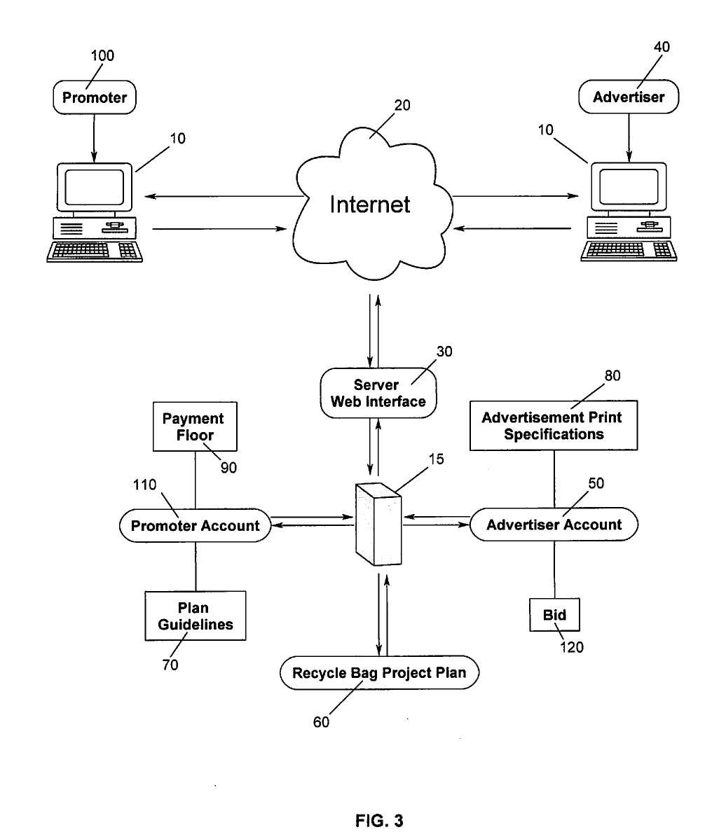

Promoter 100 accesses Internet 20 on computer 10 via step 605. Promoter 100 connects to server web interface 30 via step 610. Promoter 100 establishes promoter account 110 via step 620, wherein (as shown in FIG. 3) promoter account 110 comprises promoter alert system 115, and wherein promoter account 110 is stored on server 15.

Promoter 100 creates recycle bag project plan 60 by entering plan guidelines 70 and payment minimum 90 via step 630. Plan guidelines 70 and payment minimum 90 are stored in promoter account 110.

Payment minimum 90 comprises, for exemplary purposes, the minimum amount of money promoter 100 expects to receive from advertiser 40 for conducting recycle bag project plan 60.

Advertiser 40 accesses Internet 20 utilizing computer 10 via step 665, wherein computer 10 is in communication with Internet 20. Advertiser 40 then connects to server web interface 30 via step 660, wherein Internet 20 is in communication with server web interface 30, and wherein server web interface 30 is in communication with server 15. Advertiser 40 establishes advertiser account 50 via step 670, wherein advertiser account 50 comprises advertiser alert system 130.

Advertiser 40 then browses recycle bag project plans 60 via step 680. Advertiser 40 decides whether or not to obtain services for recycling project plan 60, wherein if advertiser 40 is not interested in obtaining services for recycle bag project plan 60, then advertiser 40 continues via step 680 to browse recycle bag project plans 60. If advertiser 40 is interested in obtaining services for recycle bag project plan 60, then advertiser 40 places bid 120 via step 695 and provides advertisement print specifications 80 via step 690, wherein advertisement print specifications 80 comprise, for exemplary purposes only, advertisements that advertiser 40 would like to utilize for recycle bag project plan 60, and further comprise, for exemplary purposes only, layout, color and size specifications. Advertisement print specifications 80 are stored in advertiser account 50, wherein advertiser account 50 and recycle bag project plan 60 are accessed via server 15. It will be recognized by those skilled in the art that advertiser 40 may store other information on advertiser account 50, such as, for exemplary purposes only, contact information, marketing plans, customer data, and the like.

If bid 120 is higher than payment minimum 90, then promoter alert system 115 sends an alert to promoter account 110 via step 697. If bid 120 is lower than payment minimum 90, then advertiser 40 receives an invalid prompt.

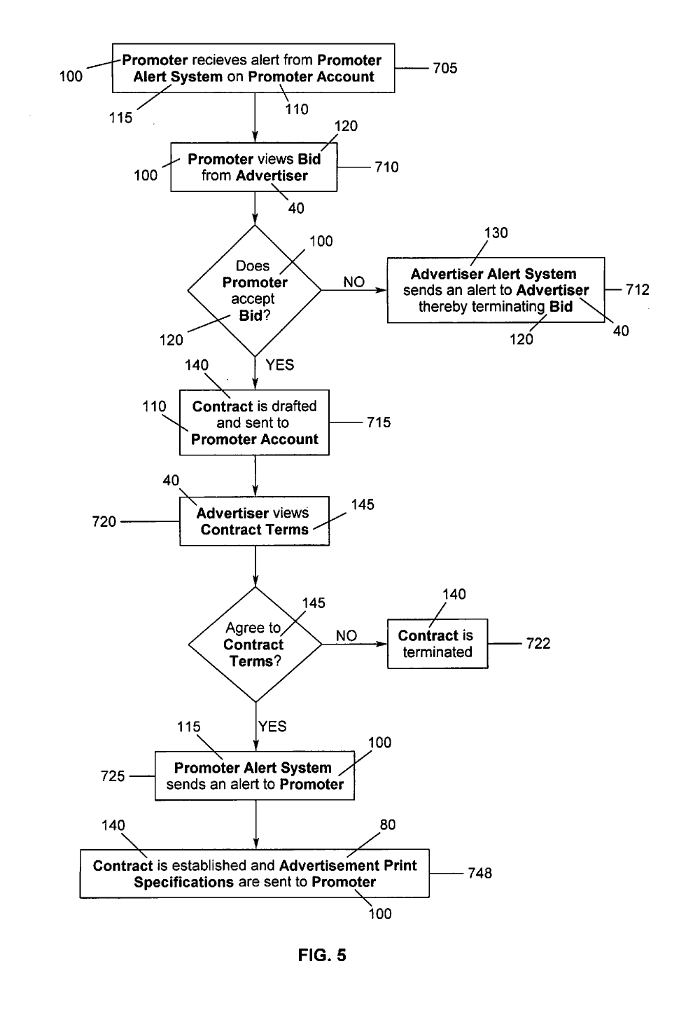

Referring now more particularly to FIGS. 3 and 5, promoter 100 receives alert from promoter alert system 115 on promoter account 110 via step 705. Promoter 100 then views bid 120 from advertiser 40 via step 710. If promoter 100 does not accept bid 120, then advertiser alert system 130 sends an alert to advertiser 40 via step 712, thereby terminating bid 120. If promoter 100 accepts bid 120, then contract 140 is drafted and sent to promoter account 110 via step 715, wherein contract 140 comprises contract terms 145, such as, for exemplary purposes only, warranty provisions, termination clauses, and the like. Advertiser 40 views contract terms 145 via step 720. If advertiser 40 does not agree to contract terms 145, then contract 140 is terminated via step 722. It will be recognized by those skilled in the art that promoter 100 and advertiser 40 may negotiate the terms of contract 140.

If advertiser 40 agrees to contract terms 145, then promoter alert system 115 sends an alert to promoter 100 via step 725. Promoter 100 receives the alert from promoter alert system 115 via step 730. If advertiser 40 agrees to contract terms 145, then contract 140 is established and advertisement print specifications 80 are sent to promoter 100 via step 748.

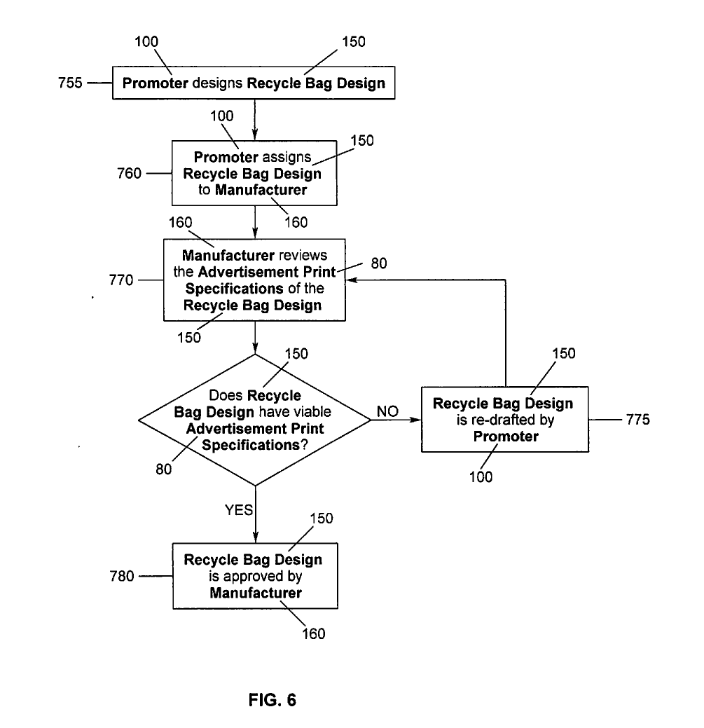

Referring now to FIGS. 3 and 6, promoter 100 designs recycle bag design 150 via step 755. Promoter 100 assigns recycle bag design 150 to manufacturer 160 via step 760. Manufacturer 160 reviews advertisement print specifications 80 of recycle bag design 150 via step 770. If recycle bag design 150 does not have viable advertisement print specifications 80, then recycle bag design 150 is re-drafted by promoter 100 via step 775, and then re-reviewed by manufacturer 160 via step 770. If recycle bag design 150 does have viable advertisement print specifications 80, then recycle bag design 150 is approved by manufacturer 160 via step 780.

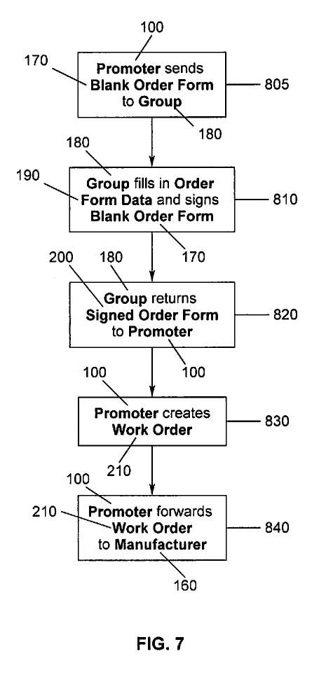

Referring now to FIG. 7, promoter 100 mails and/or electronically conveys blank order form 170 to group 180 via step 805. Group 180 completes order form 170 via step 810 with order form data 190, wherein order form data 190 comprises, for exemplary purposes only, group signature, number of bags, time of delivery, contact information, and the like. Group 180 returns signed order form 200 to promoter 100 via step 820. Promoter 100 creates work order 210 via step 830. Promoter 100 then forwards work order 210 to manufacturer 160 via step 840.

Referring now to FIGS. 1, 8 and 9, method for recycling materials 500 further comprises manufacturer 160 producing recycle bags 220 via step 520, wherein recycle bags 220 are made from, for exemplary purposes only, paper, plastic, and/or cloth. Manufacturer 160 then attaches certification tags 230 to all recycle bags 220 via step 860. Manufacturer 160 then assembles lot 280 via step 880, wherein lot 280 comprises tagged recycle bags 240, liability release form 250, certification form 260 and instruction booklet 270. Manufacturer 160 then arranges for distributor 290 to transport lot 280 via step 905 to group 180.

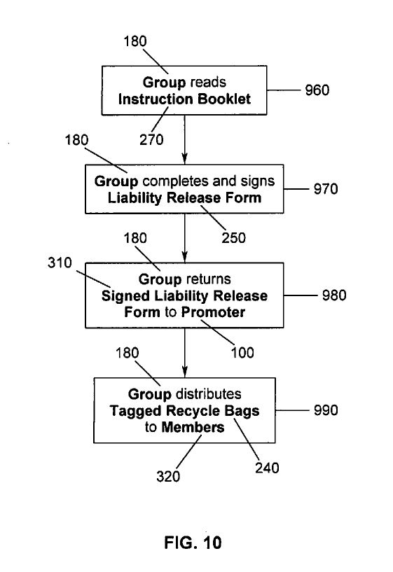

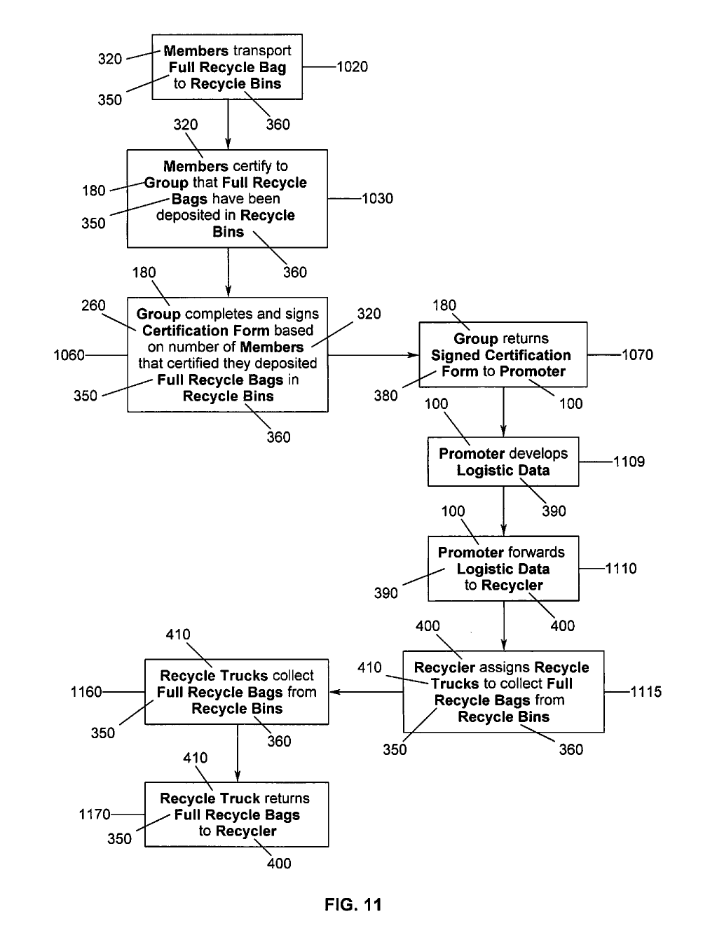

Referring now to FIGS. 1 and 10, method for recycling materials 500 further comprises the step of 530, wherein step 530 comprises distributor 290 supplying lot 280 to group 180 and providing bill of lading 300 to manufacturer 160. Group 180 reads instruction booklet 270 via step 960. Group 180 completes via step 970 liability release form 250. Group 180 returns signed liability release form 310 to promoter 100 via step 980. Group 180 then distributes tagged recycle bags 240 to members 320 via step 990.

Referring now to FIGS. 1 and 11, method for recycling materials 500 further comprises members 320 filling tagged recycle bags 240 with recyclables 330 via step 540. Members 320 transport full recycle bag 350 to recycle bins 360 via step 1020. Members 320 certify via step 1030 to group 180 that full recycle bag 350 has been deposited in recycle bins 360 step 1030. Group 180 signs via step 1060 certification form 260 based on the number of members 320 that certified that they deposited full recycle bag 350. Group 180 then returns via step 1070 signed certification form 380 to promoter 100. Promoter 100 develops logistics data 390 via step 1109, wherein logistics data 390 comprises, for exemplary purposes only, location of recycle bins, instructions for collector, and the like. Promoter 100 then forwards logistic data 380 to recycler 400 via step 1110. Recycler 400 then assigns via step 1115 recycle trucks 410 to collect full recycle bags 350 from designated recycle bins 360. Recycle trucks 410 collect full recycle bags 350 from recycle bins 360 via step 1160. Recycle trucks 410 then return full recycle bags 350 to recycler 400 via step 1170.

Referring again to FIGS. 1, 12 and 13, recycler 400 processes recyclables 330 via step 570, thereby generating second revenue stream 490. Recycler 400 tabulates the number of certification tags 230 on full recycle bags 350 on collection record 430 via step 1180. Recycler 400 subsequently calculates collection rebate 440 from processing recyclables 330 via step 1190 and sends collection rebate 440 and collection record 430 to promoter 100 via step 1195. Promoter 100 compares signed certification form 380 to collection record 430 via step 1205. If signed certification form 380 does not match collection record 430, then promoter 100 informs group 180 via step 1207 there is an error in the certification process. If signed certification form 380 does match collection record 430, then promoter 100 calculates advertisement rebate 450 via step 1209. Promoter 100 then calculates final payment 460 via step 1210. Promoter 100 then issues final payment 460 to group 180 via step 1220, wherein group 180 distributes final payment 460 to members 320 via step 1230.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method of recycling materials, wherein said method comprises the steps of:
generating a first revenue stream by forming a contract between an advertiser and a promoter via a computer;
a manufacturer producing recycle bags based on said contract;
a distributor supplying recycle bags to a group comprising members;
said members collecting recyclable materials with said recycle bags;
said members discarding full recycle bags in recycle bins;
a recycling truck conveying said full recycle bags to a recycler; and
generating a second revenue stream by said recycler processing said recyclable materials.

2. The method of claim 1, said method further comprising the steps of:
allocating a first portion of said first revenue stream to said group; and
allocating a second portion of said first revenue stream to said promoter.

3. The method of claim 2, said method further comprising the steps of:
allocating a first portion of said second revenue stream to said group; and
allocating a second portion of said second revenue stream to said recycler.

4. The method of claim 3, said method further comprising the steps of:
said promoter accessing the Internet via said computer;
said promoter connecting to a server web interface via the Internet;
said promoter establishing a promoter account; and
said promoter entering a recycle bag project plan and a payment minimum, wherein said recycle bag project plan is posted on said server web interface.

5. The method of claim 4, wherein said promoter account comprises a promoter alert system.

6. The method of claim 5, further comprising the steps of:
said advertiser accessing the Internet via said computer;
said advertiser connecting to said server web interface via said computer; and
said advertiser establishing an advertiser account.

7. The method of claim 6, wherein said advertiser account comprises an advertiser alert system.

8. The method of claim 7, further comprising the steps of:
said advertiser selecting one of said recycle bag project plans on said server web interface;
placing a bid for said one recycle bag project plan if said bid is higher than said payment minimum; and
said advertiser entering advertisement print specifications.

9. The method of claim 8, wherein said step of said advertiser entering said advertising data further comprises the step of:
said advertiser entering into said server web interface advertisement print specifications to print on said recycle bag.

10. The method of claim 9, said method further comprising the step of:
alerting said promoter via said promoter alert system when said advertiser places said bid on said one recycle bag project plan.

11. The method of claim 10, said method further comprising the steps of:
said promoter viewing said bid from said advertiser;
said promoter optionally accepting said bid from said advertiser, wherein said server web interface automatically replaces said recycle bag project plan with said contract, and wherein said contract comprises terms; and
said advertiser optionally viewing said terms of said contract.

12. The method of claim 11, said method further comprising the steps of:
alerting said promoter via said promoter alert system if said advertiser accepts said terms of said contract.

13. The method of claim 12, said method further comprising the step of:
said promoter creating a recycle bag design based on said advertisement printing specifications if said advertiser accepts said terms of said contract.

14. The method of claim 13, said method further comprising the steps of:
said promoter assigning said recycle bag design to said manufacturer; and
said manufacturer reviewing said advertisement print specifications.

15. The method of claim 14, said method further comprising the step of:
said manufacturer returning said recycle bag design to said promoter if said advertisement print specifications are not viable.

16. The method of claim 15, said method further comprising the step of:
said manufacturer approving said recycle bag design if said recycle bag design has viable specifications.

17. The method of claim 16, said method further comprising the steps of:
said promoter mailing blank order forms to said group;
said group completing said blank order forms with order form data;
said group returning signed order forms to said promoter; and
said promoter creating a work order upon receipt of said signed order forms from said group.

18. The method of claim 17, said method further comprising the steps of:
said promoter forwarding said work order to said manufacturer;
said manufacturer producing recycle bags based on said work order, wherein said manufacturer attaches certification tags to each of said recycle bags, thereby creating said tagged recycle bags; and
said manufacturer assembling a lot, wherein said lot comprises said tagged recycled bags, a liability release form, a certification form and an instruction booklet.

19. The method of claim 18, said method further comprising the steps of:
arranging for transportation of said lot via said distributor; and
said distributor conveying said lot to said group.

20. The method of claim 19, said method further comprising the steps of:
said group reading said instruction booklet;
said group signing said liability release form;
said group returning signed liability release form to said promoter; and
said group distributing said tagged recycle bags to said members.

21. The method of claim 20, said method further comprising the steps of:
said members collecting said recyclables until said tagged recycle bags are full;
filling said recycle bags with said recyclable materials;
said members transporting said full recycle bags to said recycle bin;
each of said members certifying to said group that said member deposited said full recycle bag into said recycle bin;
said group tabulating the number of said members that certified deposit of said full recycle bags into said recycle bin on said certification form;
said group signing said certification form; and
said group returning said signed certification form to said promoter.

22. The method of claim 21, said method further comprising the steps of:
said promoter generating logistic data from said signed certification form; and
said promoter forwarding said logistic data to said recycler.

23. The method of claim 22, said method further comprising the steps of:
said recycler assigning recycling trucks to collect said full recycled bags from said recycle bins;
said recycling trucks collecting said full recycle bags;
said recycler tabulating said certification tags on said full recycle bags via a collection record;
said recycling trucks depositing said full recycle bags to said recycler;
said recycling trucks submitting said collection record to said recycler;
said recycler processing said recyclable materials in said full recycle bags;
said recycler calculating a collection rebate from processing said recyclable materials to generate said second revenue stream; and
said recycler submitting said collection rebate and said collection record to said promoter.

24. The method of claim 23, said method further comprising the step of:
said promoter comparing said signed certification form to said collection record.

25. The method of claim 24, said method further comprising the step of:
said promoter sending a decline response to said group if said signed certification form does not match said collection record.

26. The method of claim 25, said method further comprising the steps of:
said promoter calculating a final payment if said signed certification forms matches said collection record;
said promoter issuing said final payment to said group; and
said group distributing said final payment to said members.

27. A method of recycling materials, wherein said method comprises the steps of:
generating a first revenue stream by forming a contract for distributing recycling bags between an advertiser and a promoter via computer bidding, wherein said recycling bags advertise said advertiser;
manufacturing said recycling bags;
distributing said recycling bags to groups, wherein a first portion of said first revenue stream is allocated to said groups and a second portion of said first revenue stream is allocated to said promoter;
collecting said recyclable materials in said recycling bag by said groups; and
generating a second revenue stream by processing said recyclable materials, wherein a first portion of said second revenue stream is allocated to said groups and a second portion of said second revenue stream is allocated to said promoter.
